(19) United States
(12) Patent Application Publication
(10) Pub. No.: US 2014/0108024 A1
(43) Pub. Date: Apr. 17, 2014

(54) SYSTEMS AND METHODS FOR MEDICAL TREATMENT PLAN VERIFICATION AND IMPLEMENTATION COMPLIANCE

(71) Applicant: MCKESSON FINANCIAL HOLDINGS, Hamilton (BM)

(72) Inventors: John EVANS, Alphretta, GA (US); Keith MERTZ, Johnstown, OH (US)

(73) Assignee: MCKESSON FINANCIAL HOLDINGS, Hamilton (BM)

(21) Appl. No.: 13/652,176

(22) Filed: Oct. 15, 2012

(51) Int. Cl. G06Q 50/22

(52) U.S. Cl. 705/2

(57) ABSTRACT

Embodiments include systems and methods for verifying treatment plans comply with treatment guidelines established by a healthcare organization. The treatment guidelines may be based, at least in part, on care guidelines generated by independent medical standards bodies. The implementation of the treatment plans may also be verified by the healthcare organization and may implement corrective actions when the treatment plan implementation is not in compliance with the approved treatment plan.

### FIELD OF THE DISCLOSURE

Embodiments of the disclosure relate generally to healthcare information, and more particularly, to systems and methods for providing compliance verification to patient care guidelines and treatment plan implementation.

### BACKGROUND

Electronic medical records have streamlined the workflows associated with providing healthcare to patients. Physicians may generate treatment plans based on a variety of research sources that are constantly being updated or amended based on new medical results or new techniques to treat medical conditions. Nurses or care givers may implement treatment plans per best practices or doctor's orders that may change over time. Electronic medical records may enable a healthcare organization to electronically document treatment plans and their implementation. However, the electronic format may enable the healthcare organization to analyze the content of the treatment plans and the effect of their implementation on patients.

### SUMMARY

This disclosure describes systems and methods for verifying if physician treatment plans comply with approved patient care guidelines and if the implementation of patient treatment complies with the treatment plans.

A healthcare organization may employ, hire, contract, collaborate, or consult with doctors, nurses, or other medical professionals to provide patient care for a variety of medical conditions. The healthcare organization may receive patient care guidelines from medical standards organizations that facilitate medical research and conduct peer reviewed medical studies to develop care guidelines for doctors to diagnose and treat patients. Generally, the medical standards organizations are not-for-profit or non-profit organizations that are managed or operated separately from healthcare organizations. For example, the medical standards organizations may include, but are not limited to: the American Heart Association™, the American Diabetes Association™, or the American Cancer Society™.

The healthcare organization may administer a server to receive the care guidelines from the medical standards organization. The healthcare organization may use the care guidelines to generate treatment guidelines for one or more medical conditions. In one instance, the care guidelines may be implemented verbatim into the treatment guidelines. In another instance, the care guidelines may be edited or amended to generate treatment guidelines approved by the healthcare organization. In one particular embodiment, the care guidelines may be converted into a compatible electronic format for the healthcare organization's server or network. Different treatment guidelines may be generated for a variety of medical conditions based, at least in part, on the care guidelines provided by a corresponding medical standards organization.

Doctors or nurse practitioners that may be authorized to diagnose medical conditions and prescribe treatments may generate treatment plans for patients that seek treatment as customers of the healthcare organization. The doctors or nurse practitioners may query the healthcare organization server for treatment guidelines based, at least in part, on their diagnosis. The query may include a specific medical condition or a list of patient symptoms and/or patient test results. The healthcare organization server may respond to the query with the recommended treatment guidelines. The doctors or nurse practitioners may select one of the treatment guidelines to generate a treatment plan for the patient. In another embodiment, the doctors or nurse practitioners may enter their own treatment plan into a computer and send the treatment plan to the healthcare organization server.

The healthcare organization server may compare the doctor's treatment plan against the treatment guidelines based on the diagnosis or the patient symptoms. The healthcare organization server may determine any deviation between the approved treatment guidelines and the doctor's treatment plan. The deviation may include an omission, a change from, or an addition to the approved treatment guidelines. The healthcare organization server may send a deviation alert message to the doctor's computing device which may delay the implementation of the treatment plan. The deviation alert message may request an explanation or justification from the doctor's computing device. The doctor's computing device may send a response comprising an explanation or a justification for the deviation. The explanation may include additional patient information that may include patient allergies or conditions that may be problematic if implemented under the approved treatment guidelines; for example, when a patient is obese and the approved treatment plan calls for using a steroid that has a side effect of significant weight gain. The doctor may want to provide an alternative medication that doesn't exacerbate an existing patient medical condition. In some embodiments, the doctor may provide patient test results to illustrate or justify the deviation. The healthcare organization server may approve the deviation based, at least in part, on an automated analysis of the doctor's response or after a supervisor has reviewed and approved the deviation.

The approved treatment plan may be sent to a nurse's computing device to enable implementation of the treatment plan. The nurse or caregiver may access the treatment plan and begin administering the ordered medications or procedures and then enter the treatment plan data into the nurse's computing device. The implementation may be sent to the healthcare organization server and compared against the doctor's treatment plan. When a deviation between the implementation data and the treatment plan is determined, the healthcare organization server may send a deviation alert message to the nurse's computing device and/or the doctor's computing device. The nurse may send an explanation for the implementation deviation to the healthcare organization server and/or the doctor's computing device. Depending on the type of deviation and the response, the doctor's computing device may send a corrective action plan to the nurse's computing device and/or the healthcare organization server. The healthcare organization server may approve the corrective action plan and send the corrective action plan to the nurse's computing device. In another embodiment, the doctor's computing device may send the corrective action plan directly to the nurse's computing device.

Other systems, methods, apparatuses, features, and aspects according to various embodiments of the disclosure will become apparent with respect to the remainder of this document.

### BRIEF DESCRIPTION OF THE DRAWINGS

The features within the drawings are numerically notated to be cross referenced with the written description. Generally, the first numeral reflects the drawing number where the feature was first introduced, and the remaining numerals are intended to distinguish the feature from the other notated features within that drawing. However, if a feature is used across several drawings, the number used to identify the feature in the drawing where the feature first appeared will be used. Reference will now be made to the accompanying drawings, which are not necessarily drawn to scale and wherein:

FIG. 1 illustrates an example block diagram of a workflow according to an example embodiment of the disclosure.

FIG. 2 illustrates an example system, according to an example embodiment of the disclosure.

FIG. 3 illustrates a flow diagram of an example method according to an example embodiment of the disclosure that may include a healthcare server.

FIG. 4 illustrates a flow diagram of an example method according to an example embodiment of the disclosure that may include a doctor's computing device.

FIG. 5 illustrates a flow diagram of an example method according to an example embodiment of the disclosure that may include a nurse's computing device.

### DETAILED DESCRIPTION

Embodiments of the disclosure will be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those of ordinary skill in the art.

Embodiments of the disclosure can provide systems, methods, and apparatuses for verifying compliance with approved guidelines for patient care when developing treatment plans by medical professionals (e.g., doctors or nurse practitioners) that are authorized to diagnose symptoms and prescribe treatment plans for patients. Once the treatment plans have been approved, the treatment plans may be provided to medical staff (e.g., nurses, therapists, pharmacy technicians, care givers, patients) to implement. The implementation of the treatment plan may be recorded and verified against the treatment plan provided by the medical professionals.

These and other embodiments are described more fully below with reference to the accompanying figures, in which embodiments of the disclosure are shown.

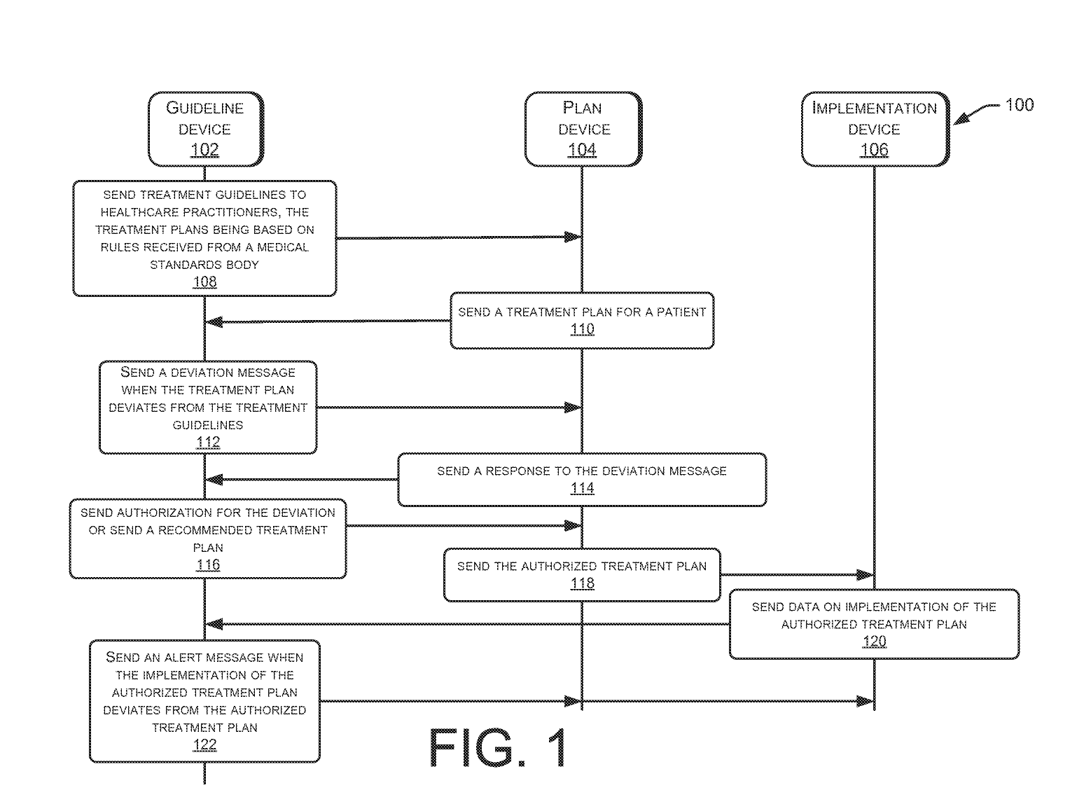

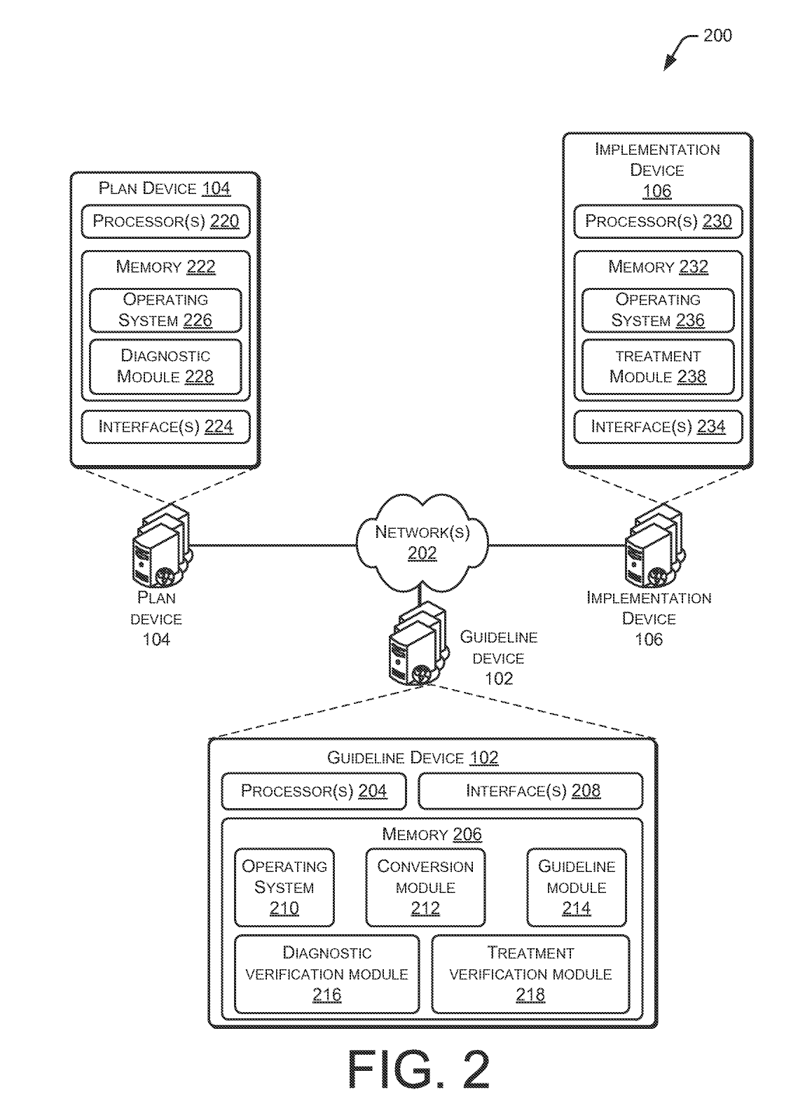

FIG. 1 illustrates an example block diagram 100 of a workflow according to an example embodiment of the disclosure that includes a guideline device 102, a plan device 104, and an implementation device 106. Although these devices as shown as separate entities, they may be included in a single device or implemented across multiple devices that are connected together by a communication network. The components of the devices 102, 104, 106 will be described in greater detail in the description of FIG. 2. However, a brief description of the device's functionality will be described with regard to FIG. 1.

A healthcare organization (not shown) may employ, hire, contract, collaborate, or consult with medical professionals (e.g., doctors, nurse practitioners) and medical staff (e.g., nurses, physical therapists . . . etc.) to treat patients with a variety of medical conditions. The healthcare organization may be financially responsible for the actions of its employees with regard to patient treatment. In some cases, the healthcare organization may want to exert oversight of the actions of its employees to standardize or enforce quality of care measures by preventing errors or omissions in the treatment of patients. In certain instances, the patient may be responsible for implementing the treatment themselves. For example, a patient may be monitoring there medical conditions at home, taking medications, or performing physical therapy that may be entered into a home health monitoring system (not shown) that would operate in a similar manner as the implementation device 106. In this way, the patient or a patient care giver (e.g., patient's spouse or family member) may be considered as part of the medical staff with regards to implementing a treatment plan.

In one embodiment, the healthcare organization may develop and authorize treatment guidelines for healthcare professionals or care givers to follow and implement. The treatment guidelines may be developed internally within the healthcare organization or they may be developed based, at least in part, on guidelines approved by medical standards bodies. The medical standards bodies may include organizations that are managed independently of the healthcare organization that conduct or collect research from throughout the healthcare industry to develop best practices for treating certain types of medical conditions. For example, the medical standards bodies may include, but are not limited to: the American Heart Association™, the American Diabetes Association™, or the American Cancer Society™. The healthcare organization may receive the treatment guidelines and convert them into an electronic format that is compatible with their computing environment (not shown). In some instances, in addition to the format changes, the healthcare organization may also edit or amend the best practices to comply with the healthcare organization's treatment guidelines or preferred treatment methods. The guideline device 102 may receive the treatment guidelines and may convert and/or edit the best practices to generate treatment guidelines approved by the healthcare organization.

At block 108, the guideline device 102 may send the treatment guidelines to the plan device 102 to be stored and accessed when the healthcare professional (e.g., doctor) diagnoses a patient and attempts to generate a treatment plan. In some cases, individual treatment guidelines may be sent to the plan device when the guideline device 102 receives a patient diagnosis or symptoms from the plan device 102. As noted above, the treatment guidelines may be based, at least in part, on the best practices published by the relevant medical standards bodies. In another embodiment, the treatment guidelines may be provided to the patient in certain circumstances in which the patient treatment is self-directed. For example, the patient may select treatment guidelines for general healthcare (e.g., losing weight, lowering cholesterol, and reducing blood sugar) that may not require doctor approval or insurance authorization.

The treatment guideline may include, but is not limited to: diagnosis confirmation procedures, medication treatments, medical device recommendations, medical device settings, medication side effects, medical procedures and side effects, or any other information that a doctor may use to diagnose or treat a medical condition. In some cases, the guideline device 102 may send more than one set of treatment guidelines that may be chosen by the doctor. For example, different medications may be used to treat the same medical condition. The doctor may be able to choose between the different medications based, at least in part, on the patient's condition, insurance coverage, side effects, or ease of use of the medication. The patient's condition may be exacerbated by certain medications and the doctor may elect to select a medication that minimizes the risk to the patient's overall wellbeing. In certain cases, insurance coverage may cover generic drugs rather than brand name drugs. The doctor may also choose between different medications based on side effects. For example, a certain drug may cause drowsiness and the patient needs to be able to take the medication at work. Accordingly, the doctor may select a medication that does not cause drowsiness. The ease of use of the drug may also impact a doctor's treatment plan. For example, one drug may be administered intravenously while another drug is taken orally. When the patient is admitted to the hospital and the intravenous drugs can be given easily, the doctor may select the intravenous drugs. However, when the medication has to be taken at home, the oral medication may be preferred because it is easier for the patient to self-administer than the intravenous medication.

At block 110, the plan device 104 may send a treatment plan generated by a doctor or nurse practitioner to the guideline device 102. The doctor may elect to generate a treatment plan based on their individual knowledge and experience. The treatment plan may include, but is not limited to: a diagnosis summary, lab results, medical test requests, medical procedures, medications, post-treatment recovery procedures, or any other type of information that may be used to treat a patient's medical condition.

In another embodiment, the doctor may select from one or more treatment guidelines sent from the guideline device 102. The treatment guidelines 102 may have been stored on the plan device 102 and are selected based, at least in part, on the diagnostic or symptom information provided by the doctor.

At block 112, the guideline device 102 may send a message to the plan device 104 when the doctor's treatment plan deviates or is different from the treatment guidelines approved by the healthcare organization.

In one instance, the doctor's treatment plan may be generated based on their experience and training. These treatment plans may omit, change, or add treatment options found in the treatment guidelines.

In another instance, the doctor's treatment plan may have been selected from the treatment guidelines stored on the plan device 104. However, the treatment guidelines may be updated or changed on a periodic or non-periodic basis. Hence, the selected treatment plan may differ from the most recent changes to the medical standards body or the healthcare organization's best practices. However, in both instances, the guideline device 102 may determine that a deviation exists between the healthcare organization's treatment guidelines and the doctor's treatment plan. Hence, the doctor may be notified of the deviation by the message that is sent from the guidelines device 102 to the plan device 104.

At block 114, the plan device 104 may send a response to the deviation message that may include an explanation or justification for the difference between the treatment guideline and the treatment plan.

The response may include an explanation for the deviation between the patient's treatment plan and the healthcare organization's treatment guidelines. The explanation may be a textual response or machine-readable response that may explain why the patient may not be a good candidate to be treated per the treatment guideline. This may include patient allergies or other medical conditions that may be exacerbated by the treatment guideline. In another instance, the response may include a justification for the deviation by including patient testing data that may indicate that the patient's condition may fall outside of the parameters of the treatment guidelines. For example, the patient's condition may be considered an outlier when compared to other patients who have the same or similar medical condition. In one instance, this may include a patient whose condition is far worse or far better than other patients with that condition. The doctor may want to deviate from the treatment guidelines to avoid over treating or under treating a patient. The doctor may increase the medication dosage for patients with a much more severe condition or decrease the medication dosage for patients that have a less severe presentation than a typical patient with that medical condition.

At block 116, the guideline device 102 may analyze the response from the plan device 102 by determining the significance of the deviation from the treatment guideline. The significance determination may include an automated determination, a severity determination, or a determination from a supervisor that oversees the doctor. Following the determination, the guideline device 102 may send an authorization or rejection notice for the proposed treatment plan. In one embodiment, the guideline device 102 may send a proposed treatment guideline for the doctor to approve or may propose recommended changes to the rejected treatment plan for the doctor to approve.

The automated determination may be designed to address less significant changes or common changes to the treatment plan that may be anticipated based on differences between patients. For example, deviations may be based, at least in part, on: age, height, weight, body temperature, blood pressure, or any other patient criteria that may impact treatment. In other instances, certain treatment steps or procedures may be omitted or added based on similar patient criteria.

The severity determination may be designed to rank or rate the severity of the treatment plan deviation from the treatment guidelines. The ranking or rating may include, but is not limited to, a number ranking, a color ranking, or a letter ranking Any type of ranking may be used that differentiates between different levels of severity. For example, a high level ranking may indicate a strong likelihood of a negative patient outcome and may initiate supervisor approval or interdiction of the treatment plan. A medium level ranking may indicate an inconsistency between the treatment guidelines and the treatment plan may result in an alert provided to the doctor. The doctor may have to acknowledge the alert or, in certain instances, provide an explanation for the inconsistency. A low level ranking may indicate the treatment plan is consistent with the treatment guideline. A confirmation notice may be provided to the doctor indicating that the treatment plan is approved.

The supervisor determination may be based, at least in part, on an employee that oversees the treatment guidelines for the doctor who submitted the treatment plan. In another instance, the supervisor may be a subject matter expert that has been designated to authorize or reject treatment guideline deviations. In one embodiment, the supervisor determination may be initiated immediately after the deviation is detected. In another embodiment, the supervisor determination may be initiated following the automated determination. For example, the automated determination may pre-screen the treatment plan for less significant deviations that may be dealt with automatically without supervisor intervention.

At block 118, the plan device 104 may send the approved treatment plan to the implementation device 106. In one embodiment, the implementation device 106 may include a nurse's computing device (not shown) or another computing device that may be accessed by the nurse or other medical staff that may interact with the patient. The medical staff may include, but are not limited to: nurses, lab technicians, physical therapists, occupational therapists, pharmacy staff, medical equipment technicians, and/or medical staff supervisors.

In the event that the treatment plan is not approved by the healthcare organization, the plan device 104 may not be able to send the treatment plan to the implementation device 106. The plane device 104 may request additional information to justify the changing the treatment plan or request a modified treatment plan that is more consistent with the treatment guidelines.

At block 120, the implementation device 106 may send implementation data related to the patient's treatment to the guideline device 102. As the medical staff implements the treatment plan, they may document the type or amount of treatment that is provided to the patient. The implementation data may include records of their actions and the patient's response to treatment. The implementation data may also include, but is not limited to: lab results, medical imaging results, actions performed with or on the patient, and/or any other medical staff functions that are requested in the doctor's treatment plan.

At block 122, the guideline device 102 may compare the implementation data to the treatment plan and determine when the medical staff omits, changes, or adds a treatment function to the treatment plan. When the implementation deviation is determined, the guideline device 102 may send an alert message to the plan device 104 and/or the implementation device 106.

In another embodiment, the doctor may use the plan device 104 to send a corrective action plan to account for the deviation from the original treatment plan. The corrective action plan may instruct the medical staff to perform actions that may counteract the impact of the treatment plan deviation.

The nurse may use the implementation device 106 to send an update following the initiation of the corrective actions provided by the guideline device 102 or the plan device 104.

FIG. 2 illustrates an example system 200 that may implement the treatment plan compliance and treatment plan implementation compliance for a healthcare organization. The system 200 may include the guideline device 102, the plan device 104, and the implementation device 106 which are in communication with each other over a network 202. At a high level, the guideline device 102 may be administered by a healthcare organization and/or a facility that may employ medical professionals and staff to treat patients. The guideline device 102 may convert medical standards bodies care guidelines to treatment guidelines that may be distributed to their employees or used to analyze the treatment plans developed by their employees. The guideline device 102 may verify that a doctor's treatment plans are compliant with the treatment guidelines when the treatment plans are being submitted via the plan device 104 to the guidelines device 102. Further, the guideline device 102 may verify that the medical staff's implementation of the doctor's treatment plans is proper. The implementation device 106 may provide the implementation results to the guideline device 102.

In one embodiment, the guideline device 102 may include one or more computer processors 204, memory 206, input/output (I/O) and network interfaces 208.

The computer processor 204 may execute computer-readable instructions stored in memory 2-6. The one or more computer processors 204 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The guideline device 102 may also include a chipset (not shown) for controlling communications between the one or more processors 204 and one or more of the other components of the guideline device 102. In certain embodiments, the guideline device 102 may be based on an Intel® Architecture system and the processor(s) 204 and chipset may be from a family of Intel® processors and chipsets, such as the Intel® Atom® processor family. The one or more processors 204 may also include one or more application-specific integrated circuits (ASICs) or application-specific standard products (ASSPs) for handling specific data processing functions or tasks.

The guideline device 102 may also include an I/O and network interface 208 which may include a variety of elements that enable the display of content and/or receiving user inputs. For instance, the I/O interface may include a display, a keyboard, a mouse, a touch screen display, a voice recognition interface, a motion recognition interface, and/or a touchpad.

A network interface may include a modem or any other communication device that enables the guideline device 102 to send and receive information over a network 202.

The memory 206 may store a variety of modules to operate the device and provide various aspects of functionality that are common to computing devices. For example, an operating system 210 may provide file management capability, interpret user inputs, and manage the resources on the consumer computer 102. The operating system 210 may provide the processor 204 with a variety of instruction sets to perform mathematical or logic operations that enable the functionality of the display and other sensory elements that present content to or receive content from the user. The memory 206 may also store one or more data files that perform a variety of tasks or operations on the guideline device 102 or that may perform tasks in conjunction with the plan device 104 and the implementation device 106. The memory 206 may include one or more volatile and/or non-volatile memory devices including, but not limited to: random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof.

The guideline device 102 may include several modules to implement guideline generation, verification of treatment plans, and verification of treatment plan implementation. The modules may include, but are not limited to: a conversion module 212, a guideline module 214, a diagnostic verification module 216, and a treatment verification module 218.

The conversion module 212 may receive care guidelines from one or more medical standards bodies that provide treatment strategies or guidelines for one or more medical conditions. The conversion module 212 may convert the care guidelines to a compatible format and/or structure that is consistent with the healthcare organization's system 200. In one embodiment, the care guidelines may be entered manually into the conversion module 212. In another embodiment, the conversion module 212 may implement a conversion algorithm that may convert the care guidelines into a compatible format.

The guideline module 214 may generate treatment guidelines from the converted care guidelines. The treatment guidelines may include at least a portion of the care guidelines. The healthcare organization may generate treatment guidelines that include all elements of the care guidelines. However, the treatment guidelines may also only include a portion of the care guidelines. The healthcare organization may omit, change, or add elements to or from the care guidelines to generate treatment guidelines that are consistent with the policies and procedures of the healthcare organization.

For example, the care guidelines may call for the use of a brand name medication. The treatment guidelines may be amended to include the generic brand of the medication. In another example, the care guidelines may call for using a specific diagnostic technique or piece of equipment. The corresponding treatment guideline may add types of diagnostic techniques or equipment available within the healthcare organization. Similarly, the treatment guidelines may also remove certain techniques or equipment that may not be available to the healthcare organization.

The care guideline modifications may also include more substantive changes that are related to the types of medications, dosages of medications, treatment procedures, or recovery procedures used for treating medical conditions. These substantive changes may be based on the experience and results of the healthcare organization's treatment of medical conditions in the past.

In one embodiment, the guideline module 214 may send the treatment guidelines to the plan device 104 so that doctors may review the treatment guidelines or select a treatment guideline to be the basis of their treatment plan. In another embodiment, the guideline module 214 may merely store the treatment guideline and use it as a comparison against treatment plans submitted from doctors who are employed or supervised by the healthcare organization.

The diagnostic verification module 216 may receive treatment plans from the plan device 104. The treatment plans may be generated by doctors or nurse practitioners using the plan device 104. In another embodiment, the treatment plans may also come from the patient within the context of the self-directed treatment plan that may not require a doctor's approval.

The treatment plans may be compared to the treatment guidelines generated by the guideline module and approved by the healthcare organization on how to diagnose and/or treat a variety of medical conditions. This comparison may be used to determine any deviations between the treatment guidelines and the treatment plans. The deviations may any include, but are not limited to, omissions, changes, or additions of treatment elements or procedures to the treatment guidelines. The deviations may include, but are not limited to, changes in medication, medication dosage, treatment procedures, sequencing of treatment procedures, and/or any other action that a doctor may order when treating a patient.

When the deviation is determined, the diagnostic verification module 216 may send a message to the plan device 104 to alert the doctor that a deviation exists between the treatment guidelines and their treatment plan. In one embodiment, the message may be only for notification purposes and the plan device 104 may not be prevented from providing the treatment plan to the implementation device 106. In another embodiment, the message may direct the doctor to submit another treatment plan that is consistent with the treatment guidelines. In this instance, the message may prevent the plan device 104 from sending the treatment plan to the implementation device 106. In yet another embodiment, the message may direct the doctor to submit another treatment plan or an explanation for the deviation from the treatment guidelines. The message may also prevent the plan device 104 from sending the rejected treatment plan to the implementation device 106. When the diagnostic verification module 216 receives the explanation or an alternative treatment plan, the deviation determination may be completed again or the explanation may be reviewed by a supervisor. An authorization message may be sent to the plan device 104 when the deviation determination indicates that the alternative treatment plan is consistent with the treatment guidelines. The authorization message may enable the plan device 104 to submit the alternative treatment plan to the implementation device 106. Similarly, when the explanation for the deviation is approved, an explanation authorization message may be sent to the plan device 104 and the treatment plan may be sent to the implementation device 106.

In another embodiment, the explanation may require data to substantiate the deviation from the treatment guidelines. The diagnostic verification module 216 may send a request for additional information either automatically or at the direction of the supervisor. In certain instances, the design verification module 216 may implement a decision tree algorithm to determine the type of patient information or test results the doctor may need to provide based, at least in part, on the type of deviation detected. For example, when a doctor's treatment plan calls for the use of a medication that is not included in the treatment guideline, the doctor may need to provide an explanation for the additional medication. In another instance, the doctor's treatment plan may not use the recommended dosage of a medication. The doctor may need to provide data that indicates why the dosage has changed. For example, the patient may exhibit symptoms or conditions that are outside the normal distribution of patient's that have the same medical condition. This may include, but is not limited to, higher/lower weight, higher/lower blood pressure, or the fact that the severity of the symptoms is higher or lower than the symptoms of other patients that have the same or similar medical condition. When the diagnostic verification module 216 receives the additional data, the treatment plan may be approved and an authorization message may be sent to the plan device 104. The authorization message may enable the plan device to send the treatment plan to the implementation device 106.

The treatment verification module 218 may determine any deviations between the treatment plan and the implementation of the treatment plan done by the medical staff or the doctor. The medical staff may include any employee, consultant, patient, or contractor of the healthcare organization that may provide treatment to patients. The medical staff may include, but is not limited to: nurses, nurse's aides, physical therapists, occupational therapists, lab technicians, medical equipment technicians, or any other person who may provide treatment to a patient. The person may also include the patient who may be responsible for implementing a portion of the treatment plan. For example, the patient may take their medication and/or perform tests (e.g., blood pressure) when they are at home. The patient implementation data may be collected and provided to the treatment verification module by a home health device (e.g., laptop, set top box, phone, watch . . . etc.).

In one embodiment, the treatment plan may comprise a set of instructions for the medical staff to implement to treat a patient with a medical condition. The instructions may specify the type of medications, procedures, or techniques to employ when treating a patient. When the instructions are completed, the medical staff may document their completion using the implementation device 106. The completed instructions may be sent to the treatment verification module 218 to be compared against the approved treatment plan. The comparison may include, but is not limited to, verifying the type of task completed, the sequence of the task relative to other tasks included in the treatment plan, and/or the timing of the completed task. In one instance, the completed task may also include data related to the task. This may apply to testing tasks included in the treatment plan. The testing results may be included in the data provided to the treatment verification module 218. The results may be compared to expected results included in the treatment plan or in the treatment guidelines. When the testing results deviate from the expected results, a notification message may be sent to the doctor (e.g., plan device 104) and the responsible medical staff (e.g., implementation device 106). The treatment verification module 218 may send a corrective action plan or request that the doctor provide a corrective action plan in view of the deviation.

Although the diagnostic verification module 216 and the treatment verification module 218 are shown to reside in the guideline device 102, in another embodiment, they may also be incorporated into the plan device 104 or the implementation device 106 instead of the guideline device 102. In this way, the functionality of the system 200 is not entirely dependent upon when components of the system 200 perform the tasks or functions described above in the descriptions of FIGS. 1 and/or 2.

The system 200 may also include the plan device 102 which may include one or more computer processors 220, memory 222, input/output (I/O) and network interface 224 which may be used to implement treatment plan generation and to facilitate patient treatment in conjunction with the guideline device 102 and the implementation device 106.

The computer processors 220 may execute computer-readable instructions stored in memory 222. The one or more computer processors 220 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The processing capability may the same or similar to the processing capability described in the guideline device 102.

The memory 222 may store a variety of modules to operate the plan device 102 and provide various aspects of functionality that are common to computing devices. For example, an operating system 226 may provide file management capability, interpret user inputs, and manage the resources on the plan device 104. The operating system 226 may provide the processor 220 with a variety of instruction sets to perform mathematical or logic operations that enable the functionality of the display and other sensory elements that present content to or receive content from the user. The memory 222 may include one or more volatile and/or non-volatile memory devices including, but not limited to random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof.

The memory 128 may also store one or more computer-readable instructions that perform a variety of tasks or operations on the plan device 104 or that may perform tasks in conjunction with the guideline device 102 and/or the implementation device 106. For instance, the plan device 104 may include, but is not limited to, a diagnostic module 238 that enables a medical professional to generate patient treatment plans or to select patient treatment plans from among the treatment guidelines provided by the guideline device 102.

Doctors or nurse practitioners may generate their treatment plans and store them in memory 222 until they are approved for transmission to the implementation device 106. In the interim, the diagnostic module 226 may send the treatment plans to the guideline device 102 for approval. When the treatment plan is approved, the diagnostic module 236 may send the treatment device to the implementation device 106. The medical staff may view the treatment plan using the implementation device 106 and may begin implementing the treatment plan.

However, the treatment plan may be rejected by the guideline device 102. In this instance, the diagnostic module 236 may receive a request to explain or justify aspects of the treatment plan that are not consistent with or deviate from the treatment guidelines. The diagnostic module 236 may receive the explanation from the doctor and send the response to the guideline device 102. In the alternative, the doctor may amend the treatment plan to be consistent with the treatment guidelines and submit the amended treatment plan for approval.

The diagnostic module 236 may also be used to generate corrective action plans to address treatment plan implementation issues. For example, when the treatment plan is implemented improperly, the diagnostic module 236 may receive a notification of the incident. The doctor may take corrective action to compensate for or minimize any negative effects from the error. The corrective action plan may be sent to the guideline device 102 for approval or directly to the implementation device 106 for the medical staff to implement the corrective action plan as needed. In the prior instance, the corrective action plan may be provided to the implementation device when the guideline device 102 authorizes the correction action plan.

The plan device 104 may also include an I/O and network interface 224 which may include a variety of elements that enable the display of content and/or receiving user inputs. For instance, the I/O interface may include: a display, a keyboard, a mouse, a touch screen display, a voice recognition interface, a motion recognition interface, and/or a touchpad. The network interface that may include a modem or any other communication device that enables the plan device 104 to send and receive information over a network 202 and/or the internet.

The system 200 may also include the implementation device 106 that receives the treatment plans and documents the implementation of the treatment plans. The documentation may include implementation data that indicates the type of tasks or care that is provided to the patient. The implementation data may include, but is not limited to: medication type, medication dosage, when the medication was taken, procedure type, procedure results, or a patient's vital signs (e.g., pulse, blood pressure . . . etc.). The implementation device 106 may include: one or more computer processors 230, memory 232, input/output (I/O), and a network interface 234.

The computer processor 230 may execute computer-readable instructions stored in memory 232. The one or more computer processors 230 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The processing capability may the same or similar to the processing capability described in the guideline device 102.

The memory 232 may store a variety of modules to operate the device and provide various aspects of functionality that are common to computing devices. For example, an operating system 236 may provide file management capability, interpret user inputs, and manage the resources on the implementation device 106. The operating system 236 may provide the processor 230 with a variety of instruction sets to perform mathematical or logic operations that enable the functionality of the display and other sensory elements that present content to or receive content from the user. The memory 232 may include one or more volatile and/or non-volatile memory devices including, but not limited to: random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof.

The implementation device 106 may include, but is not limited to, a treatment module 238 that may receive treatment plans and send treatment plan implementation data to the plan device and/or the guideline device 102.

Medical staff (e.g., nurses . . . etc.) may interface with the implementation device 102 to view treatment plan instructions that have prescribed by doctors or nurse practitioners. When the medical staff completes a portion of the treatment plan, the medical staff may enter a record of the completed portion into the treatment module 238. The record may be sent to the guideline device 102 (or the plan device 106) to determine if the record is consistent with or deviates from the treatment plan.

When the medical staff's actions comply with the treatment plan, the treatment module 238 may receive an acknowledgement indicating compliance was achieved. However, when the medical staff's actions do not comply with the treatment plan, the treatment module 238 may receive a request to explain or justify the deviation. The medical staff may respond to the request by entering the explanation via the treatment module 238. The treatment module 238 may also receive a corrective action plan from the guideline device 102 or the plan device 104. The treatment module 238 may also alert the medical staff supervisor to take appropriate corrective action to minimize the impact of the treatment plan deviation.

The implementation device 106 may also include an I/O and network interfaces 234 which may include a variety of elements that enable the display of content and/or or receiving user inputs. For instance, the I/O interface may include: a display, a keyboard, a mouse, a touch screen display, a voice recognition interface, a motion recognition interface, and/or a touchpad. The network interface which may include a modem or any other communication device that enables the implementation device 106 to send and receive information over a network 202.

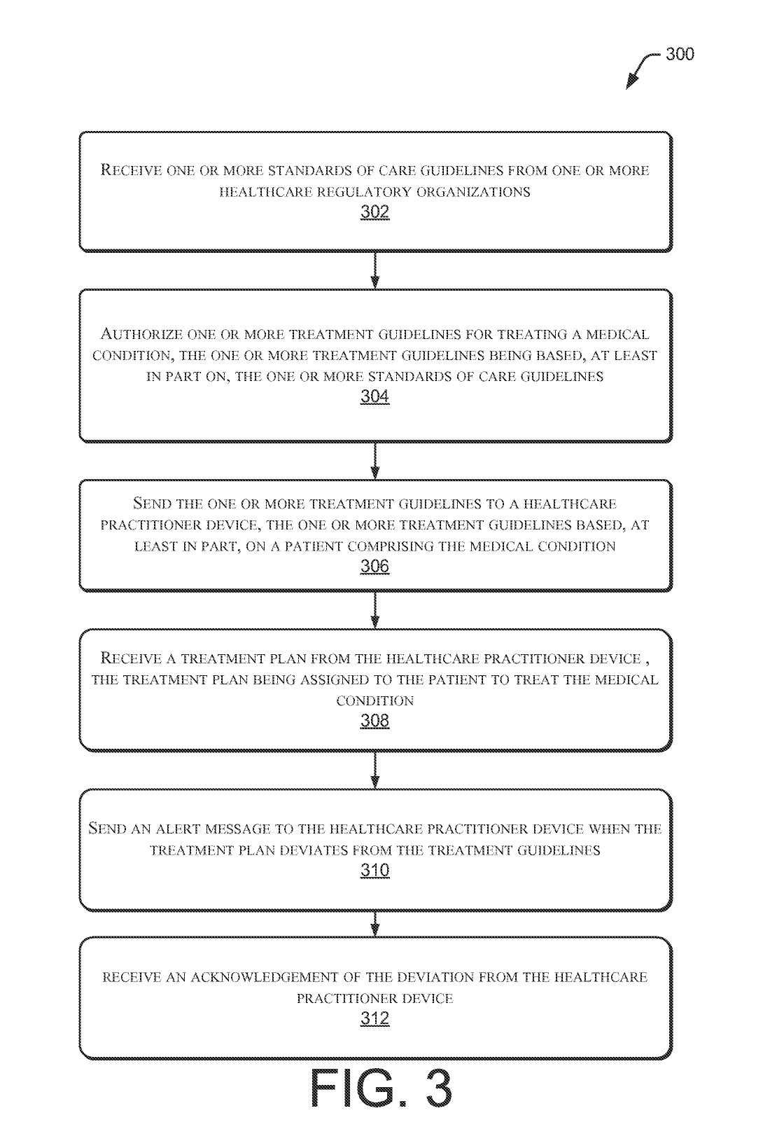

FIG. 3 illustrates a flow diagram of an example method 300 for generating treatment guidelines based, at least in part, on care guidelines published by one or more medical standards bodies. The method 300 may also include verifying that the treatment guidelines are complied with by the employees and staff of a healthcare organization. The healthcare organization may include, but is not limited to: an outpatient facility, an inpatient facility, a long term care facility, a short term care facility, a medical research facility, a pharmacy, a home-health agency, a physical therapy facility, or an occupational therapy facility. Method 300 is taken from the point of view of the guideline device 102. It should be noted that method 300 is one embodiment and other embodiments may omit or alter the sequencing of the method 300 operations.

At block 302, the guideline device 102 may receive one or more standards of care guidelines from one or more healthcare regulatory organizations or medical standards bodies. As noted above, the medical standards bodies may be independently managed from the healthcare organization that provides patient treatment. The care guidelines may be generated by independent peer-reviewed research or collated from research generated by the healthcare community at large. In one embodiment, the care guidelines may represent a basic foundation for treating medical conditions and may be amended by the healthcare organization as needed.

The guideline device 102 may convert the care guidelines into the treatment guidelines that are approved by the healthcare provider organization. The conversion process may include, but is not limited to, an electronic conversion of the care guidelines to a format that is compatible with the healthcare organization's system 200. The format may be compatible with the healthcare practitioner's device (e.g., plan device 104) and the treatment provider's device (e.g., implementation device 106).

At block 304, the guideline device 102 may authorize one or more treatment guidelines for treating a medical condition, the one or more treatment guidelines being based, at least in part, on the one or more standards of care guidelines.

The care guidelines may be amended to suit the capabilities and/or experience of the healthcare organization. For example, the care guidelines may suggest using a certain technique to diagnose or treat a medical condition. In certain instances, the healthcare organization may not have the capability to perform that technique or may have determined that the technique is less accurate or reliable than other techniques. The healthcare organization may also be bound by other regulatory rules or guidelines that may make following the care guidelines impractical or inefficient.

The treatment guidelines may be employed to standardize the treatment of patients within the healthcare organization. However, the treatment guidelines may be modified by the doctors based on the current patient's condition. In one embodiment, the treatment guideline modification may be implemented at the doctor's discretion. In another embodiment, the treatment guideline modification may need to be approved by the healthcare organization before beginning treatment. This embodiment will discussed in greater detail in the description of block 310 and 312 of the method 300.

At block 306, the guideline device 102 may send the one or more treatment guidelines to a healthcare practitioner device (e.g., plan device 104). The one or more treatment guidelines based, at least in part, on a patient being diagnosed with the respective medical condition. The guideline device 102 may use the network 202 to send the treatment guideline to the plan device 104.

At block 308, the guideline device 102 may receive a treatment plan from the healthcare practitioner device with the treatment plan being the proposed treatment plan generated by the doctor using the plan device 104.

At block 310, the guideline device 102 may send an alert message to the healthcare practitioner device when the treatment plan deviates from the treatment guidelines. The deviation may include, but not is limited to, an omission from the one or more treatment guidelines, a change to the one or more guidelines, or an addition to the one or more treatment guidelines.

In one embodiment, the alert message may include a questionnaire to determine the cause of the deviation. The questionnaire may include several medical condition specific questions to be answered by the doctor. In one embodiment, the questionnaire may also include answers in a multiple choice format that may clarify the severity of the medical condition or may specify other related medical conditions that may be related to the diagnosed medical condition.

At block 312, the guideline device 102 may receive an acknowledgement of the deviation from the healthcare practitioner device. The acknowledgement may include a written explanation for the deviation or may include the completed questionnaire.

In another embodiment, the guideline device 102 may send the written explanation or the questionnaire to a supervisor. Once the supervisor has approved the deviation, the guideline device 102 may send an authorization message to the plan device 104 to distribute the treatment plan as needed.

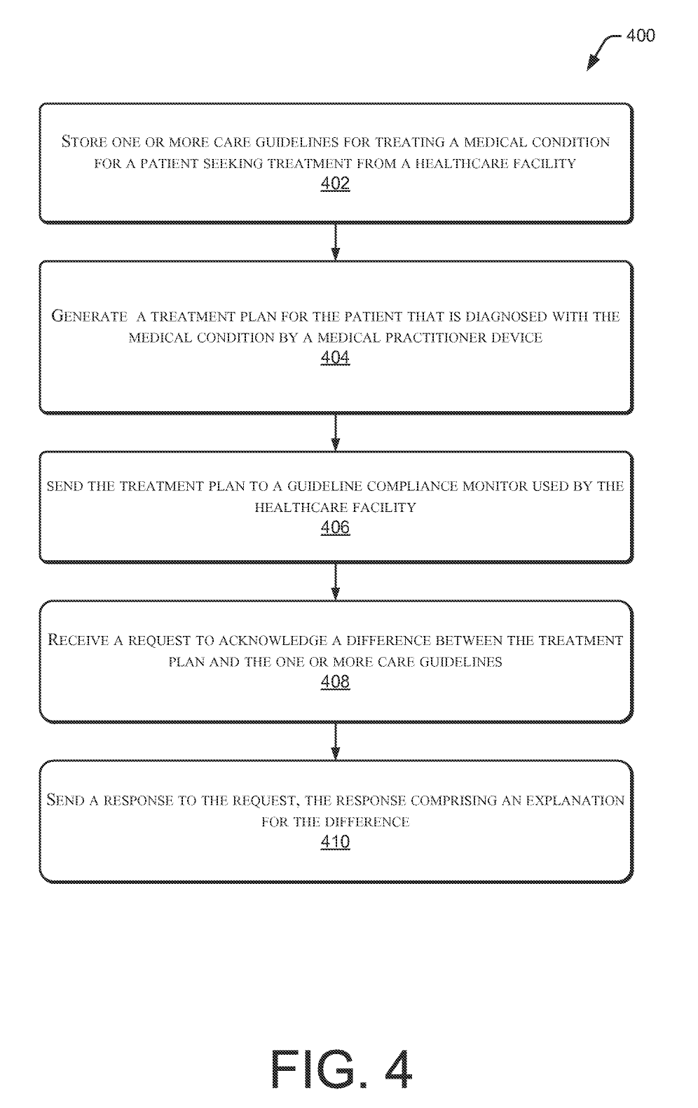

FIG. 4 illustrates a flow diagram of an example method 400 for generating a treatment plan and distributing the treatment plan after receiving approval from the healthcare organization. Method 400 is taken from the point of view of the plan device 104. It should be noted that method 400 is one embodiment and other embodiments may omit or alter the sequencing of the method 400 operations.

At block 402, the plan device 104 may receive one or more treatment guidelines for treating a medical condition for a patient seeking treatment from a healthcare facility. As noted above, the treatment guidelines may be based, at least in part, on the care guidelines generated by a medical standards body. The treatment guidelines may be approved by the healthcare organization that manages the healthcare facility.

At block 404, the plan device 104 may generate a treatment plan for the patient that is diagnosed with the medical condition. A doctor or nurse practitioner may direct the generation of the treatment plan by selecting one or more of the treatment guidelines as the treatment plan. Alternatively, the doctor or nurse may prescribe a treatment plan independently of the treatment guidelines. For example, the independently generated treatment plan may be based on the training and experience of the doctor or nurse practitioner.

At block 406, the plan device 104 may send the treatment plan to a guideline compliance monitor used by the healthcare facility. The guideline compliance monitor may determine when the treatment plan deviates from the treatment guidelines. The guideline device 102 may operate as the guideline compliance monitor.

At block 408, the plan device 104 may receive a request to acknowledge a difference between the treatment plan and the one or more treatment guidelines. The request may include a questionnaire that the doctor may complete or a response that includes a written explanation for the difference that may be generated by the doctor.

At block 410, the plan device 104 may send a response to the request, with the response comprising an explanation for the difference as indicated in the written explanation or the questionnaire.

In one embodiment, plan device 103 may receive an authorization for the difference from a supervisor assigned to the healthcare facility. Accordingly, the plan device 104 may send the treatment guideline to a treatment implementation application (e.g., application device 106) operated by the healthcare facility.

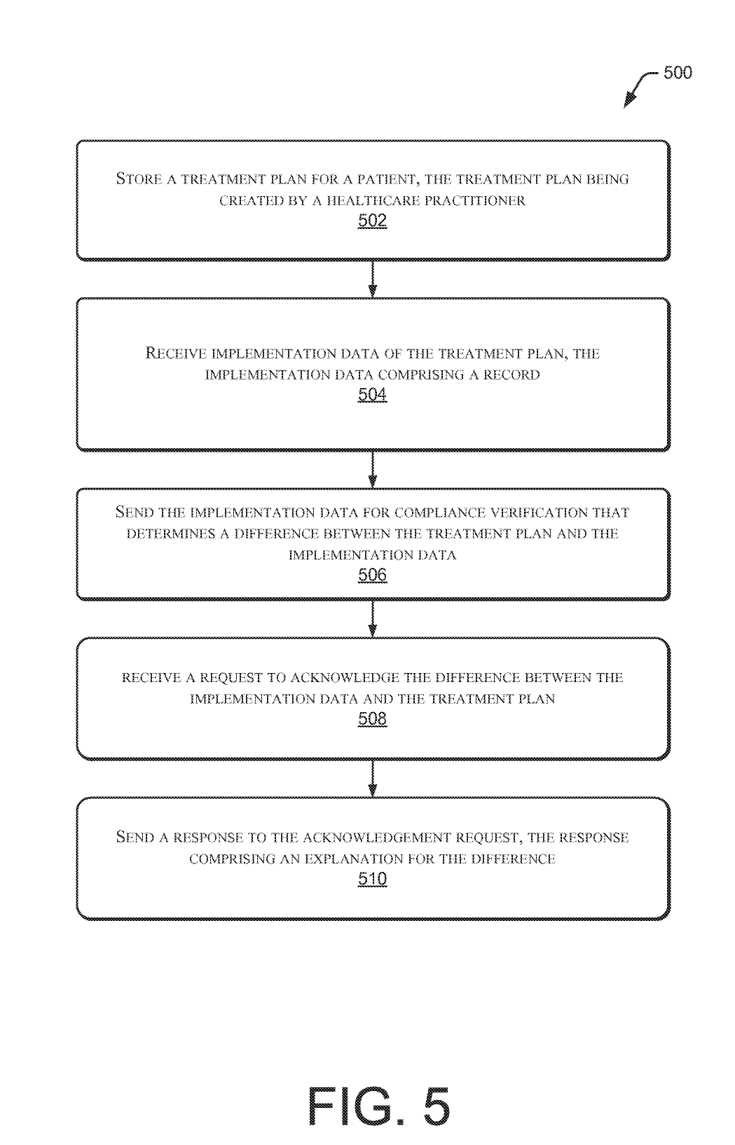

FIG. 5 illustrates a flow diagram of an example method 500 for sending implementation data for a patient treatment plan and responding when the implementation data indicates a deviation from treatment plan. Method 500 is taken from the point of view of the implementation device 106. It should be noted that method 500 is one embodiment and other embodiments may omit or alter the sequencing of the method 500 operations.

At block 502, the implementation device 106 may receive a treatment plan for a patient from the plan device 104 with the treatment plan having been approved by the attending doctor and the healthcare organization compliance monitor.

At block 504, the implementation device 106 may receive the implementation data of the treatment plan with the implementation data comprising a record of patient treatment. In one embodiment, the implementation data may include one or more medications provided to the patient and the dosages of the one or more medications. In another embodiment, the implementation data may include physical therapy instructions provided to the patient, food that was provided to the patient, exercise that was performed by the patient, and/or a medical device that was provided to the patient.

In another embodiment, the implementation data may also include results from testing the patient, with the testing comprising one or more of the following: bodily fluid testing, imaging testing, range of motion testing, blood pressure testing, body temperature testing, pulse rate testing; hearing testing, vocal testing, sense of smell testing, sense of taste testing, reflex testing, or eye testing

At block 506, the implementation device 106 may send the implementation data for compliance verification of the medical staff's actions against the approved treatment plan. The guideline device 102 may perform the compliance verification and determining if the medical staff's action were consistent with the treatment plan prescribed by the doctor.

At block 508, the implementation device 106 may receive a request to acknowledge the difference between the implementation data and the treatment plan when the medical staff's actions are determined to deviate from the approved treatment plan. The request may include a questionnaire that requests certain information that may be specific to the type of medical condition being treated.

At block 510, the implementation device 106 may send a response to the acknowledgement request, with the response comprising an explanation for the difference between the medical staffs actions and the treatment plan.

In another embodiment, the method 500 may further comprise receiving a corrective action plan to account for the difference between the implementation data and the treatment plan.

### CONCLUSION

Many modifications and other embodiments of the disclosure will come to mind to one skilled in the art to which this disclosure pertains and having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

The claimed disclosure is:

1. A method comprising:
storing, in memory, one or more standards of care guidelines from one or more healthcare regulatory organizations;
authorizing, using a computer processor, one or more treatment guidelines for treating a medical condition, the one or more treatment guidelines being based, at least in part on, the one or more standards of care guidelines;
sending the one or more treatment guidelines to a healthcare practitioner device. the one or more treatment guidelines based, at least in part, on a patient comprising the medical condition;
receiving a treatment plan from the healthcare practitioner device, the treatment plan being assigned to the patient to treat the medical condition;
sending an alert message to the healthcare practitioner device when the treatment plan deviates from the treatment guidelines; and
receiving an acknowledgement of the deviation from the healthcare practitioner device.

2. The method of claim 1, further comprising:
receiving an explanation for the deviation;
sending the explanation to a supervisor device of the healthcare practitioner device; and
receiving authorization for the deviation from the supervisor device.

3. The method of claim 1, further comprising:
providing a questionnaire to determine the cause of the deviation; and
receiving a completed questionnaire indicating the cause of the deviation.

4. The method of claim 1, wherein the deviation comprises an omission from the one or more treatment guidelines, a change to the one or more guidelines, or an addition to the one or more treatment guidelines.

5. The method of claim 1, further comprising:
converting standards of care guidelines to the treatment guidelines for a healthcare provider organization that supervises or is associated with the healthcare practitioner device.

6. The method of claim 1, wherein the healthcare practitioner is supervised by a healthcare provider organization that comprises one or more of the following:
an outpatient facility;
an inpatient facility;
a long term care facility;
a short term care facility;
a medical research facility;
a pharmacy;
a home-health agency;
a physical therapy facility; or
an occupational therapy facility.

7. The method of claim 6, wherein the one or more healthcare regulatory organizations are managed independently of the healthcare provider organization.

8. A method comprising:
storing, in memory, one or more treatment guidelines for treating a medical condition for a patient seeking treatment from a healthcare facility;
generating, using a computer processor, a treatment plan for the patient that is diagnosed with the medical condition by a medical practitioner device;
sending the treatment plan to a guideline compliance monitor used by the healthcare facility;
receiving a request to acknowledge a difference between the treatment plan and the one or more treatment guidelines; and
sending a response to the request, the response comprising an explanation for the difference.

9. The method of claim 7, further comprising:
receiving an authorization for the difference from a supervisor assigned to the healthcare facility; and
sending the treatment guideline to a treatment implementation application operated by the healthcare facility.

10. The method of claim 7, wherein the one or more treatment guidelines are based, at least in part, on standards of care established by a medical standards organization that is managed independently of the healthcare facility.

11. A method comprising:
storing, in memory, a treatment plan for a patient, the treatment plan being created by a healthcare practitioner;
receiving implementation data of the treatment plan, the implementation data comprising a record of patient treatment;
sending, using a communication device, the implementation data for compliance verification that determines a difference between the treatment plan and the implementation data;
receiving a request to acknowledge the difference between the implementation data and the treatment plan; and
sending a response to the acknowledgement request, the response comprising an explanation for the difference.

12. The method of claim 11, wherein the implementation data comprises one or more medications provided to the patient and dosages of the one or more medications.

13. The method of claim 11, wherein the implementation data comprises instructions provided to the patient by a doctor or medical staff.

14. The method of claim of claim 11, wherein the implementation data comprises one or more of the following:
food that was provided to or consumed by the patient;
exercise that was performed by the patient;
a medical device or application that was provided to the patient; and
results from testing conducted on the patient
results from monitoring patient activity.

15. A system comprising:
one or more memory that store computer-executable instructions;
one or more computer processors configured to access the at least one memory and execute the computer-executable instructions to:
send one or more treatment guidelines for a medical condition to a healthcare practitioner device;
receive a treatment plan from the healthcare practitioner device, the treatment plan being assigned to the patient to treat the medical condition;
determine the treatment plan deviates from the treatment guidelines when the treatment plan comprises at least one portion of the treatment guidelines that has been omitted, changed, or added to in the treatment plan;
send an alert message to the healthcare practitioner device when the treatment plan deviates from the treatment guidelines; and
receive an acknowledgement of the deviation, the acknowledgement comprising a reason for the deviation.

16. A system comprising:
one or more memory that store computer-executable instructions;
one or more computer processors configured to access the at least one memory and execute the computer-executable instructions to:
generate a treatment plan for the patient that is diagnosed with the medical condition by a medical practitioner;
send the treatment plan to a guideline compliance monitor operated by the healthcare facility;
receive a request to acknowledge a difference between the treatment plan and the one or more treatment guidelines; and
send a response to the request, the response comprising a justification for the difference.

17. The system of claim 16, wherein the guideline compliance monitor determines the difference between the treatment plan and the one or more treatment guidelines.

18. The system of claim 16, wherein the justification comprises personal health information for the patient and an explanation for the difference between the treatment plan and the one or more treatment guidelines.

19. One or more tangible computer readable storage media comprises computer-executable instructions that, when executed by one or more processors, configure the one or more processors to:
receiving a treatment plan for a patient, the treatment plan being created by a healthcare practitioner;
receiving implementation data of the treatment plan, the implementation data comprising a record of patient treatment;
sending the implementation data for compliance verification that determines a difference between the treatment plan and the implementation data;
receiving a request to acknowledge the difference between the implementation data and the treatment plan; and
sending a response to the acknowledgement request, the response comprising an explanation for the difference.

20. The tangible computer readable storage media of claim 19, further comprising receiving a corrective action plan to account for the difference between the implementation data and the treatment plan.
